(19) United States
(12) Patent Application Publication
(10) Pub. No.: US 2002/0090431 A1
(43) Pub. Date: Jul. 11, 2002

(54) Method of curing and processing poultry products

(76) Inventor: Ralph Weldy, Schererville, IN (US)

Correspondence Address: BELL, BOYD & LLOYD, LLC, PO BOX 1135, CHICAGO, IL, 60690-1135, US

(21) Appl. No.: 10/039,004

(22) Filed: Jan. 4, 2002

Related U.S. Application Data
(60) Provisional application No. 60/260,008, filed on Jan. 4, 2001.

(51) Int. Cl. A23K 1/00

(52) U.S. Cl. 426/332

(57) ABSTRACT

Methods of curing and processing poultry and meat products into fully-cooked slices. The method of the present invention immerses individual poultry and meat slices into a seasoning solution sufficient for the solution to permeate each slice followed by a single heating step that fully-cooks the slices to desired doneness.

### RELATED APPLICATION

This application relates to provisional application serial No. 60/260,008, filed Jan. 4, 2001.

### TECHNICAL FIELD

The present invention generally relates to curing and processing poultry and meat products and in particular to methods for curing and processing sliced poultry and beef products.

### BACKGROUND OF THE INVENTION

To impart a smoked or cured flavor to beef and poultry, a smokehouse treatment was employed. Historically, this treatment was achieved by slow cooking in smokehouses or in oven conditions which imparted the desired flavor characteristics. Modem techniques employ cooking ovens which heat the product to a core temperature of 115°-140° F. during a 4 to 5 hour cook cycle. The “smokehouse” treatment cooks-off the marinade solution leaving behind the seasoning carried in the solution both curing the meat and poultry and imparting a desired flavor profile.

Prior to exposing the product to such a treatment whole poultry or meat parts were injected with a pickle or marinade solution. Following such injection, whole meat and poultry parts were maintained for a selected period of time sufficient for the product to absorb the marinade or pickle solution. Thereafter, the infused meat or poultry product was slow cooked to a desired doneness and thereafter sliced into selected thickness and commercial sizes.

It is apparent from the above that prior art methods are both time and energy intensive and contribute greatly to the cost of producing cured and flavored meat and poultry products. In addition with the market for fully cooked and flavored sliced poultry and meat product gaining in consumer popularity, prior to the development of the present invention, a need existed for methods to cure and process poultry and meat products by reducing the costs and time associated with injecting whole poultry and meat products with marinade or pickle solutions followed by time consuming slow cooking methods.

### SUMMARY OF THE INVENTION

According to the present invention, a novel method of curing and processing poultry, game, beef and other lean meat products into filly cooked sliced product has been developed that eliminates both marinade injection and smokehouse or other slow-cooling treatments with a significant reduction in processing time and cost. Essentially, the methods of the present invention immerse individual, thin slices of a product into a bath of marinade solution for a time period sufficient for the solution to permeate each slice. Thereafter, each slice is fully cooked to a desired doneness.

The time period for immersion of the slices is a function of the porosity, moisture content and absorptive characteristics of the muscle tissue. Immersion times of between 3 to 30 seconds have been found sufficient to permeate and fully moisturize each slice. Thereafter, the permeated slices are exposed to rapid heating.

Other advantages and aspects of the present invention will become apparent from the following detailed description of the invention.

### DETAILED DESCRIPTION

While this invention is susceptible of embodiment in many different forms, there is herein described in detail preferred embodiments of the invention with the understanding that the present disclosure is to be considered as an exemplification of the principles of the invention and is not intended to limit the broad aspect of the invention to the embodiments illustrated.

The method of the present invention may be practiced preferably by the following steps.

Whole parts of poultry, such as chicken, turkey, ducks or geese of a selected weight and size are chilled to 22° F. to 25° F. The whole pieces are sliced into individual slices of a thickness sufficient to cause each slice to readily absorb a marinade solution in less than 30 seconds throughout the entire slice.

Next, the individual slices are immersed in a marinade tank containing liquid seasoning solution of the type commonly used in the art. The slices remain immersed in the marinade tank for less than 60 seconds. The individual slices are then immediately transferred to a cooking device. This device may include a conveyor belt having a heat conductive surface (also known as “belt grilling”) or, as preferably practiced, by passing the slices on a conveyor belt through one or more microwave cooking chambers.

While the specific embodiments have been illustrated and described with reference to a preferred commercial operation, numerous modifications come to mind depending on the variables presented by other commercial operations, all without significantly departing from the spirit and intent of the invention. For example, the methods of the present invention may also be practiced on other game and other lean meat and poultry products. The scope of protection is only limited by the scope of the accompanying claims with reference to this specification.

I claim:

1. A method of curing and processing sliced poultry on a commercial scale, the method omitting the steps of injecting marinade solution into whole muscle parts and smokehouse treatment of the poultry, consisting essentially of the steps:
providing a chilled whole poultry part;
slicing the chilled part into individual slices, the slices being of such thickness so as to absorb fully a seasoning liquid solution;
immersing the individual slices into the seasoning liquid solution;
maintaining the individual slices in the seasoning solution for a time period sufficient for each slice to fully absorb the solution;
removing the individual slices from the solution;
transferring the slices to a means for heating; and
heating of the slices until the slices are fully cooked.
